(19) United States
(12) Patent Application Publication
(10) Pub. No.: US 2014/0100976 A1
(43) Pub. Date: Apr. 10, 2014

(54) SYSTEMS AND METHODS FOR IMPLEMENTING A TRAVELER-SPECIFIC STORE USING MOBILE DEVICES IN A MOBILE RETAIL ENVIRONMENT

(71) Applicant: GUESTLOGIX, INC., Toronto (CA)

(72) Inventors: Jose-Manuel Aldomar, Toronto (CA); Ramez Hanna, Toronto (CA)

(73) Assignee: GUESTLOGIX, INC., Toronto (CA)

(21) Appl. No.: 13/646,280

(22) Filed: Oct. 5, 2012

(51) Int. Cl. G06Q 30/06; G06Q 20/20

(52) U.S. Cl. 705/21; 705/26.1; 705/27.1

(57) ABSTRACT

One aspect of the invention is directed to integrating mobile devices, such as smartphones, tablets, etc., into a mobile retail environment commercial system. A mobile device includes a mobile store module that provides an interactive user experience that allows a traveler to browse goods or services that are available in the mobile retail environment. The device further includes a mobile store inventory records module that maintains records of goods and services that are available in each particular mobile retail environment. An update module facilitates data connectivity with a remote server to update the stored data in the mobile store inventory records module. The remote server, in turn, is communicatively coupled with a transportation service provider system, such as an airline business system that provides information on individual travelers and their itineraries. The mobile device further includes an in-flight data exchange module that facilitates interaction with a point-of-sale device.

### PRIOR APPLICATIONS

This application claims the benefit of U.S. patent application Ser. No. 13/253,961, filed Oct. 5, 2011, which claims the benefit of U.S. Provisional Applications No. 61/390,067 filed Oct. 5, 2010, and U.S. Provisional Application No. 61/530,111 filed Sep. 1, 2011, the disclosures of all of which are incorporated by reference into the present disclosure.

### FIELD OF THE INVENTION

The invention relates generally to information technology and, more particularly, to data processing and communication systems that facilitate travel-related commerce in mobile retail environments.

### BACKGROUND OF THE INVENTION

Today's travel industry is faced with a myriad of economic and operational challenges, from price pressure to rising fuel prices, to labor issues, to competition from other carriers and alternative loyalty programs, to name a few. In recent years, airlines have turned to a variety of alternative sources of revenue such as baggage check fees, charging for meals, and charging for the use of in-flight entertainment systems. Unfortunately, many of these new fees are alienating customers who have been accustomed to receiving services such as baggage checking and meals, without having to pay extra for them. Carriers are therefore seeking out opportunities to provide services that add value to their customers' travel experience, which is expected to be much better received than tactics of exacting new fees from existing services.

Airline operators, for instance, first discovered ancillary revenue opportunities through advertising sales in their branded on-board magazines and buy-on board programs involving duty-free goods. This eventually spread to online bookings and self-check-in options. Today, airlines are using their web sites to sell seats, insurance, car rentals and hotel reservations. Others have extended this buying to on-board programs to provide a la carte meals and drinks, lottery tickets, phone cards, on-demand entertainment, and more. With the advent of on-board Wi-Fi communications airlines are moving into a position to reap more profits from their captive audiences than ever before.

Although the opportunity to tap the market of in-transit passengers has been known for decades, a number of particular challenges has prevented deployment of a commercial infrastructure to in-transit passengers. For example, crew personnel are not retail sales staff and would need to be trained to acquire retail sales skills. Also, there are practical difficulties in transacting with customers who are passengers seated throughout the airplane. Furthermore, importantly, the retail environment in a moving vehicle is dynamic, meaning that the inventory and services available for purchase are entirely dependent on the unique characteristics of each flight leg.

Another factor specific to mobile retail is that passengers are often on a travel itinerary having stopovers or changeovers, such that the particular flight on which a given passenger may be enticed to make a purchase is not the final leg of that passenger's travel. In this scenario, for items purchased on-board to be delivered at the destination point, the inventory from which a passenger may shop is unique to the passenger's itinerary.

U.S. patent application Ser. No. 12/481,505, the disclosure of which is incorporated by reference herein, describes a solution for linking a passenger's travel itinerary to mobile retail environments with their specific product or service offerings, and for coordinating sales, provisioning, and other critical activities in connection with conducting sales or delivery of goods and services to or from those mobile retail environments. This approach facilitates pre-ordering goods or services for delivery to the customer on a vehicle or at a destination. A Web-based application is contemplated for pre-ordering goods prior to boarding the vehicles, which is linked to a back office system that tracks flight schedules, traveler itineraries, provisioning and stocking information, etc. On board the vehicles, point-of-sale devices that can display available goods or services, guide customers through a shopping session, and even take a payment, are described. These may take the form of a hand-portable device that can be operated or brought to customers by flight attendants, or a seat-back entertainment system. These devices are updated with inventory and other relevant information whenever a network connection is, or becomes, available, such as at destination points.

One drawback with the deployment of portable in-vehicle point-of-sale systems is their limited quantity aboard any vehicle. Thus, only a small fraction of the passengers can use them to browse or purchase goods or services at any one time. Seat-back entertainment systems are more widely distributed, but only on aircraft where they are available. Thousands of older aircraft in use today do not have such systems available. Moreover, seat-back systems vary in their capabilities, with many being display-only devices lacking user interactivity capability to support a shopping session.

Mobile devices such as smartphones, tablets, and the like, have become ubiquitous in recent years. In 2010, for example, about one-third of all mobile phones were smartphones. Smartphones are mobile devices that combine the functionality of a personal digital assistant and a mobile telephone. These devices have significant data communications and computing capability, along with a display and input device technology capable of facilitating effective user interaction with the quantity of information that the devices can support. Popular examples of smartphones include products manufactured by Research In Motion Inc. under the Blackberry® brand, the iPhone® by Apple Inc., and a variety of devices running Google's Android, Nokia's Symbian and Microsoft's Windows® Phone 7, operating systems.

Although smartphones, like any other computing device with network connectivity, can be used to pre-order goods or services (prior to boarding) for later delivery in a mobile retail environment, their conventional use for shopping and placing orders while en route is limited to only those flights where Internet connectivity is available. In reality, Internet service is not currently available on all aircraft and all airlines. When it is available, there is typically a charge to access the service, which may dissuade certain users. Additionally, there are practical bandwidth limitations or limitations on the number of users that can be supported at any given time on a flight. Accordingly, although it is likely that a majority of passengers on a flight are carrying a smartphone, there is currently a lost opportunity to leverage that technology in order to facilitate the sale of goods or services through such devices on-board.

### SUMMARY OF THE INVENTION

One aspect of the invention is directed to integrating mobile devices, such as smartphones, tablets, and the like, into a travel and mobile retail environment commercial system. In one embodiment, a mobile device includes a mobile store module that provides an interactive user experience that allows a traveler to browse goods or services that are available in the mobile retail environment. The device further includes a mobile store inventory records module that maintains records of goods and services that are available in each particular mobile retail environment. An update module included in the mobile device facilitates data connectivity with a remote server to update the stored data in the mobile store inventory records module. The remote server, in turn, is communicatively coupled with a transportation service provider system, such as an airline business system that provides information on individual travelers and their itineraries. The mobile device further includes an in-flight data exchange module that facilitates interaction with a point-of-sale device.

### BRIEF DESCRIPTION OF THE DRAWINGS

The invention may be more completely understood in consideration of the following detailed description of various embodiments of the invention in connection with the accompanying drawings, in which:

FIG. 1 is a block diagram illustrating a general arrangement for a mobile retail environment system according to one embodiment.

FIG. 2A is an architecture diagram illustrating various access layer and presentation layer services provided by the system of FIG. 1 according to one embodiment.

FIGS. 2B-2Q are block diagrams illustrating examples of each of the services of FIG. 2A.

FIG. 3 is a block diagram illustrating a mobile host module adapted for a mobile device according to one embodiment which enables the mobile device to become integrated into the system of FIG. 1.

FIGS. 4A and 4B are flow diagrams illustrating a preparation process and an in-flight offline process to facilitate a sale in a mobile retail environment according to one embodiment of the present invention in which a mobile device is configured with a mobile host module.

FIG. 5 is a block diagram illustrating a mobile host module according to one embodiment that is adapted for a mobile point-of-sale server.

FIGS. 6A and 6B are flow diagrams illustrating a preparation process and an in-flight offline process to facilitate a sale in a mobile retail environment according to one embodiment of the present invention in which a point-of-sale server is configured with a mobile host module.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

One aspect of the invention is directed to integrating mobile devices, such as smartphones, tablets, and the like, into a travel and mobile retail environment commercial system. The retail environment is termed mobile because the place where the shoppers are located is a vehicle, such as an aircraft, train, ship, bus, automobile, and the like. For the sake of simplicity, the embodiments of the invention detailed below shall be described in the context of an aircraft, where the shoppers, or customers, are passengers that are either on board the aircraft, or are persons who will be present on board the aircraft at a specified future time. In this case, the operator of the aircraft, or the carrier, is an airline company. It will be understood, however, that the invention as a whole is not limited to the case of airlines and aircraft as the mobile environment in which the mobile retail environment is facilitated, unless such a limitation is expressly made in a claim, in which case only that claim shall be so limited. Persons of skill in the relevant arts will appreciate that principles of the invention can be applied to any suitable type of vehicle and transportation service.

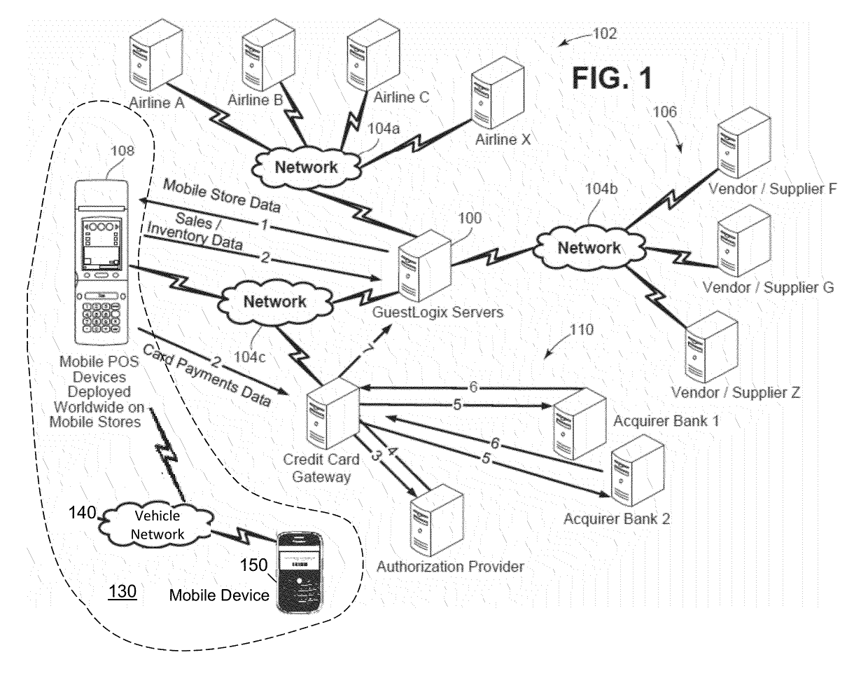

FIG. 1A is a top-level system diagram illustrating various interactions between some of the components of a mobile retail environment according to one type of embodiment. The Servers 100 interface with computer systems of each of airlines A, B, C, and X (collectively, airlines 102) over computer network 104a. The Servers 100 can utilize any suitable arrangement known in the art using well-known hardware and software platforms for their basic operation. The specific system implementation that embodies aspects of the invention utilizing the basic platforms will be detailed below. Servers 100 also interface with computer systems of each of vendors/suppliers F, G, and Z (collectively, vendors 106) via network 104b. Network 104b can be the same network as network 104a (e.g., the Internet), or they can be entirely separate networks.

Servers 100 are further interfaced with payment processing system 110, including a credit card gateway, an authorization provider, and acquirer banks, as illustrated in FIG. 1A. These systems communicate with a back office system (BOS) of Servers 100 to automate the completion of financial transactions.

Servers 100 are also interfaced with point-of-sale (POS) devices 108 situated on-board each of the aircraft 130, via network 104c, which can be the same as, or different, from networks 104a and 104b. There can be one or more POS devices 108 on each aircraft. POS devices 108 are computer devices that have a display device and a user input device, such as a keyboard or touchscreen, for example. POS devices also have a processor, memory, and communications circuitry. In one type of embodiment, POS devices 108 are hand-portable devices that may include a receipt printer and credit card reader. Other forms of input devices, such as a bar code reader, may be included. In another type of embodiment, POS devices 108 are mounted on-board the aircraft, such as in the back of most seats or in the bulkhead walls. These types of devices can be integrated with on-board media players that display videos and videogames, output sound to a set of headphones, and can include a touchscreen, videogame controller, or a variety of other input and output devices.

In one type of embodiment, equipment on each aircraft 130 supports a vehicle network 140. Vehicle network 140, in one embodiment, includes Wi-Fi wireless connectivity between devices in the network and can include one or more servers, internetworking devices such as routers or firewalls, and endpoint devices such as POS devices 108 and mobile devices 150. In another embodiment, vehicle network 140 is an ad-hoc network in which POS devices 108 can communicate with one another or with other devices directly, thereby establishing the vehicle network 140.

Mobile device 150 represents a passenger or crew member's own personal device that can connect to vehicle network 140. Mobile device 150 can be a smartphone, tablet, laptop PC, netbook, or any other portable information device. Generally, it is contemplated that mobile device 150 regularly connects to a wide area network such as the Internet on a regular basis, such as via cellular data networks like LTE (4G), HSPA+ (3G), GSM/3GSM, or the like, through a service provided by a communications carrier. Other types of mobile devices 150 connect to a wide area network via Wi-Fi or Wi-MAX access points such as hotspots at airports and those provided by municipalities or businesses.

In general, servers 100 facilitate information exchange with the airlines 102 to obtain each traveler's itinerary and other critical information, with vendors or suppliers 106 to obtain and provide information concerning goods or services to be sold and ultimately delivered during travel or at each traveler's destination. Servers 100 establish mobile stores that exist temporarily, such as during a flight from departure to arrival and exchange all critical information relating to merchandising and sales with POS devices 108. In one particular aspect of the invention, information pertaining to flight schedules, departures, destinations, and status, as well as individual passenger identification and itineraries, and crew information, received from the various airlines, is combined with information relating to the various products and services, received from the various vendors or suppliers of those products and services, to specifically define each mobile retail environment. The mobile retail environment can be vehicle-specific, and vehicle- and passenger-specific. In another embodiment, the mobile retail environment can further be crew-specific. For passengers having travel itineraries with connection points, those passengers may experience multiple different mobile retail environments, with each environment corresponding to each leg of their travel.

In a simple scenario, servers 100 are in constant communication with each vehicle, and are able to conduct merchandising and sales in real-time to travelers on-board the vehicles. In practice, however, the on-board store during transit oftentimes does not have this connection. For instance, it is still common for aircraft to not be equipped with in-flight Internet connectivity. Accordingly, in these scenarios, POS devices 108 are communicated with and updated between flights.

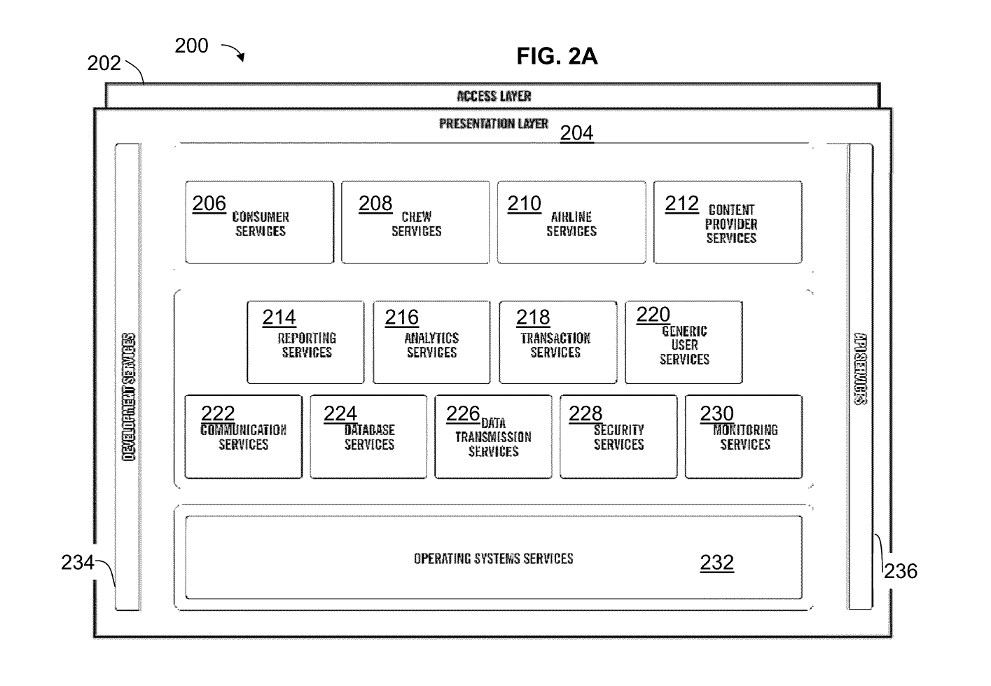

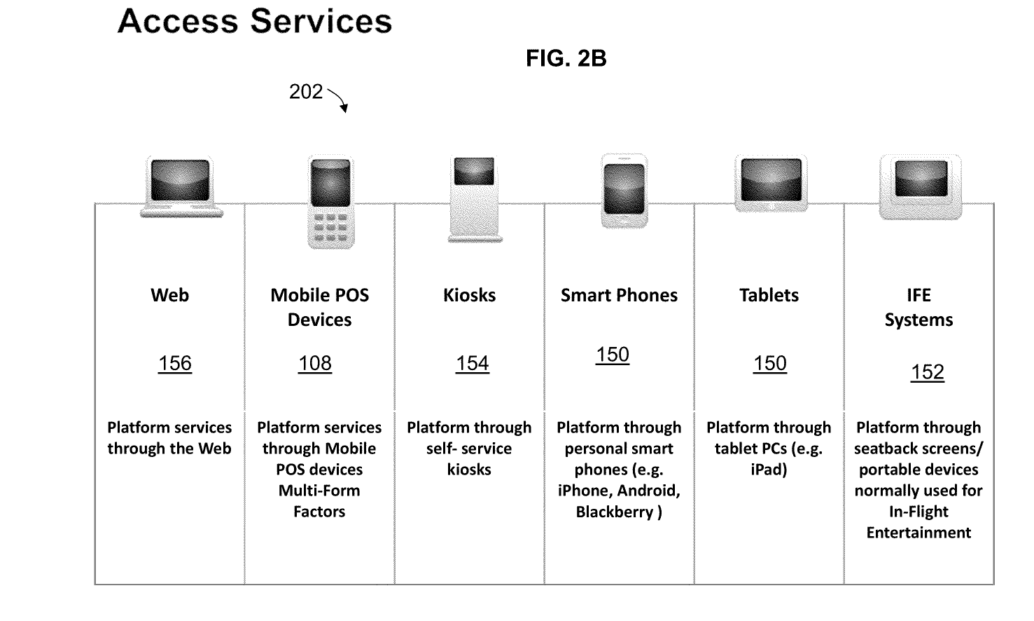

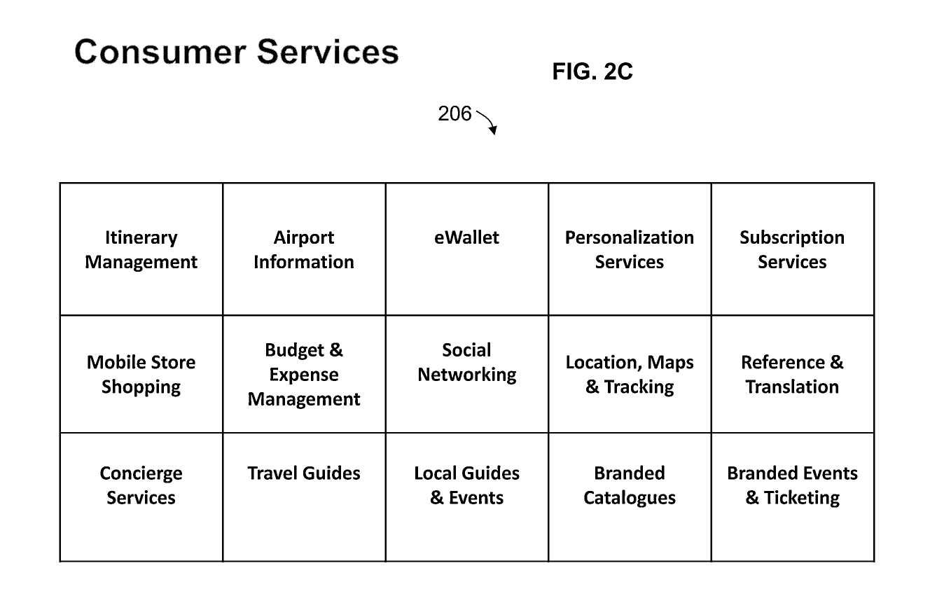

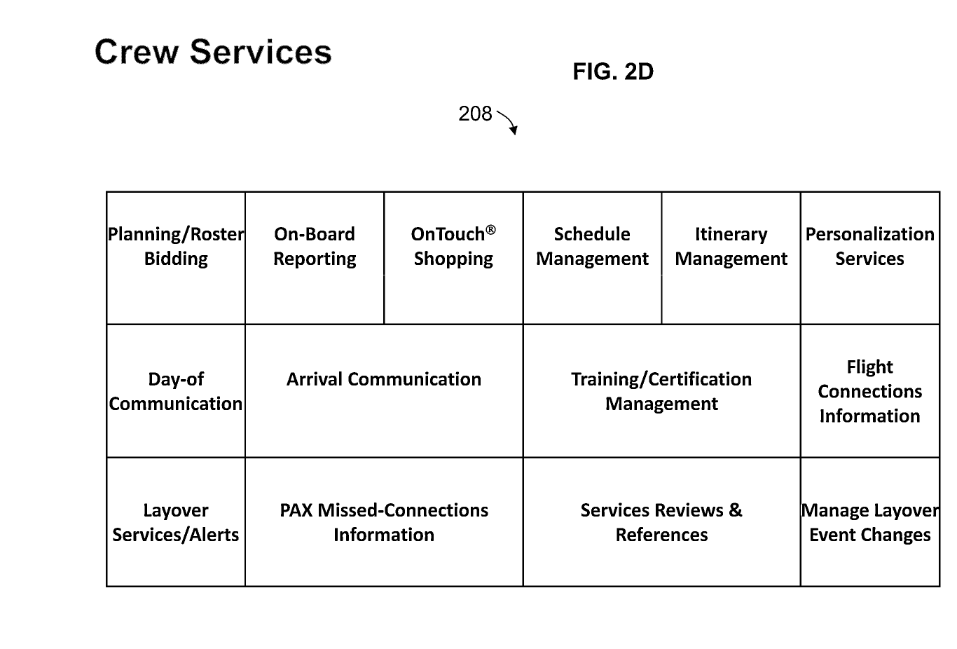

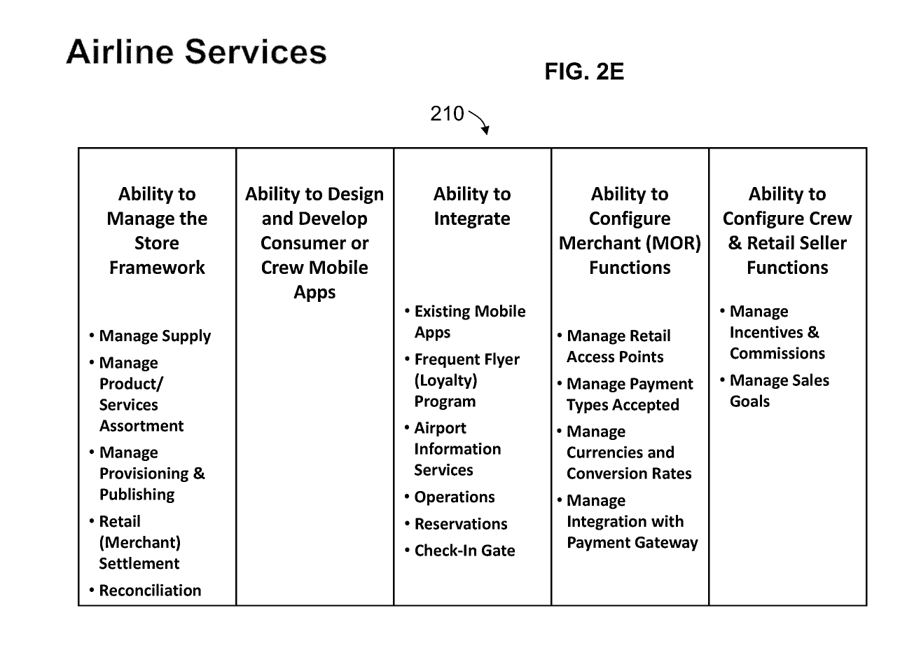

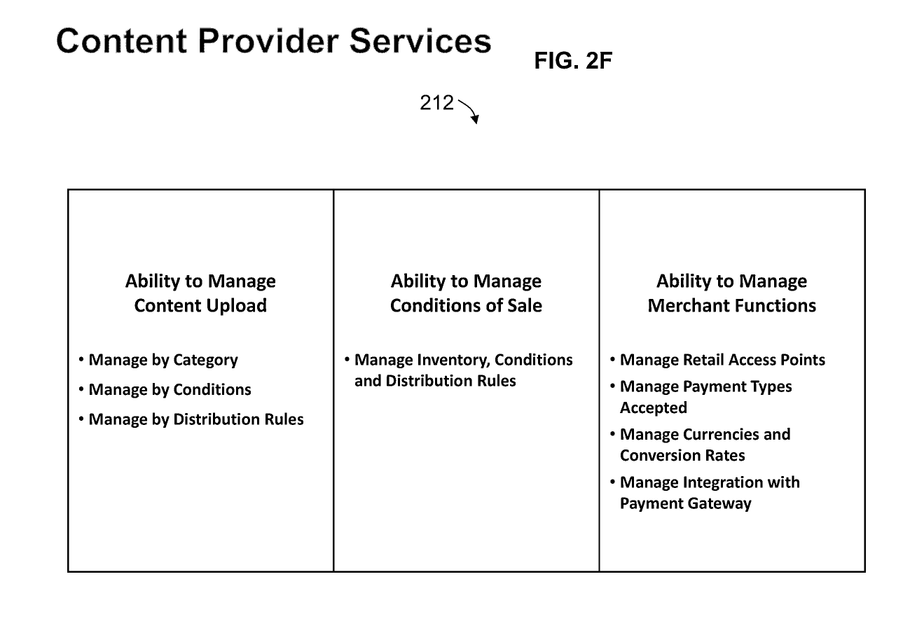

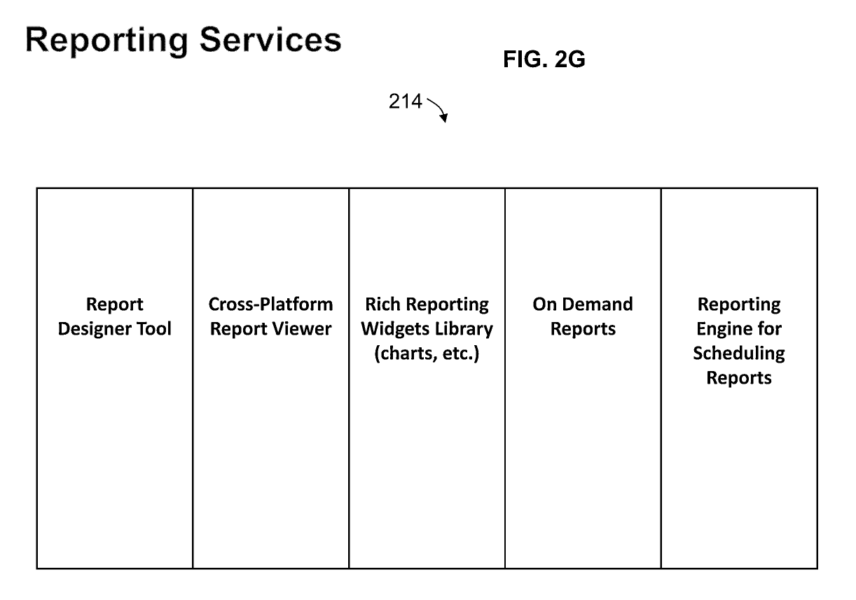

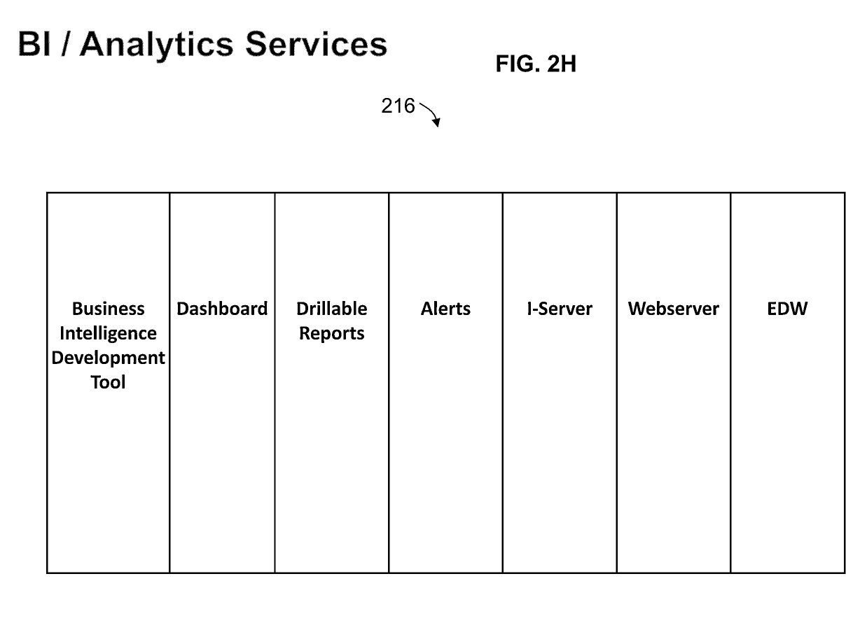

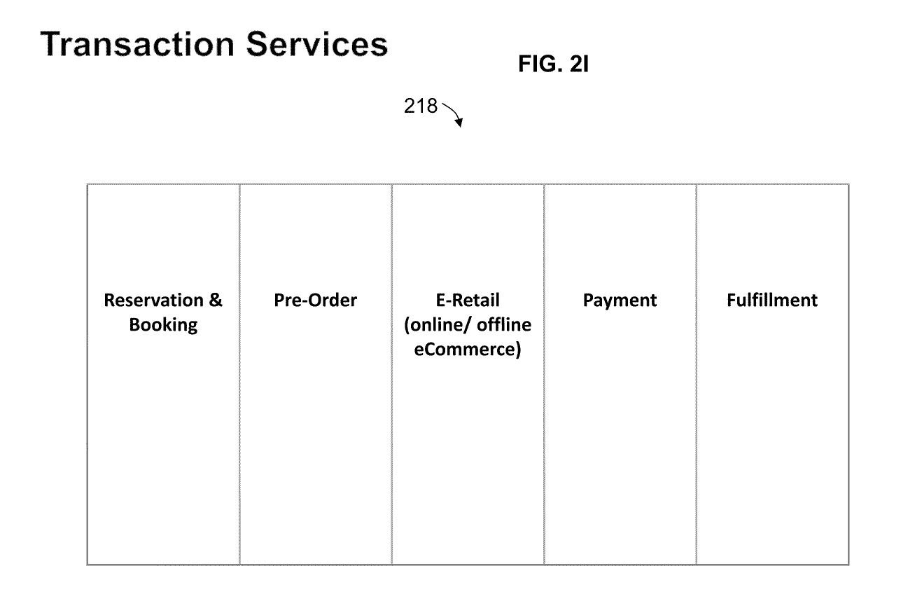

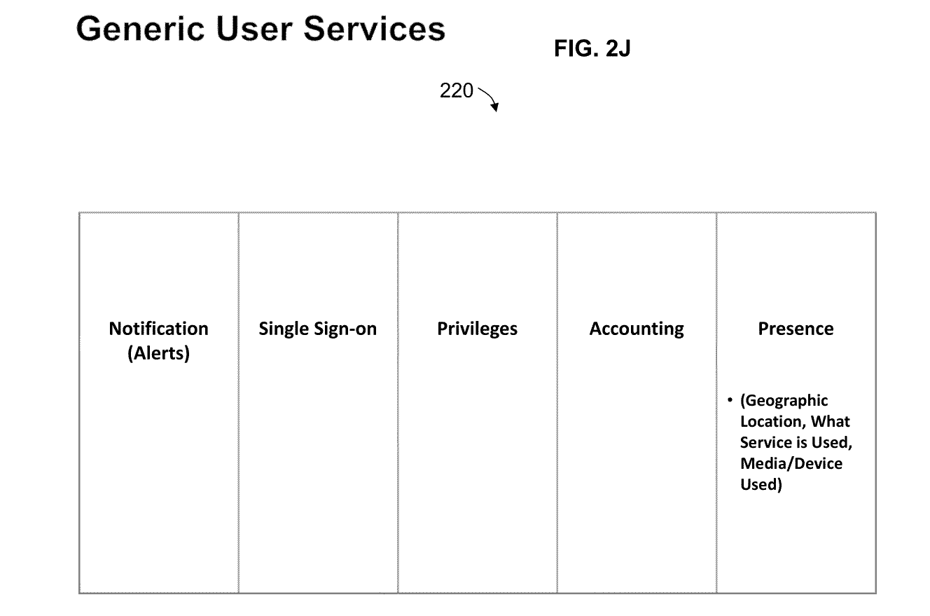

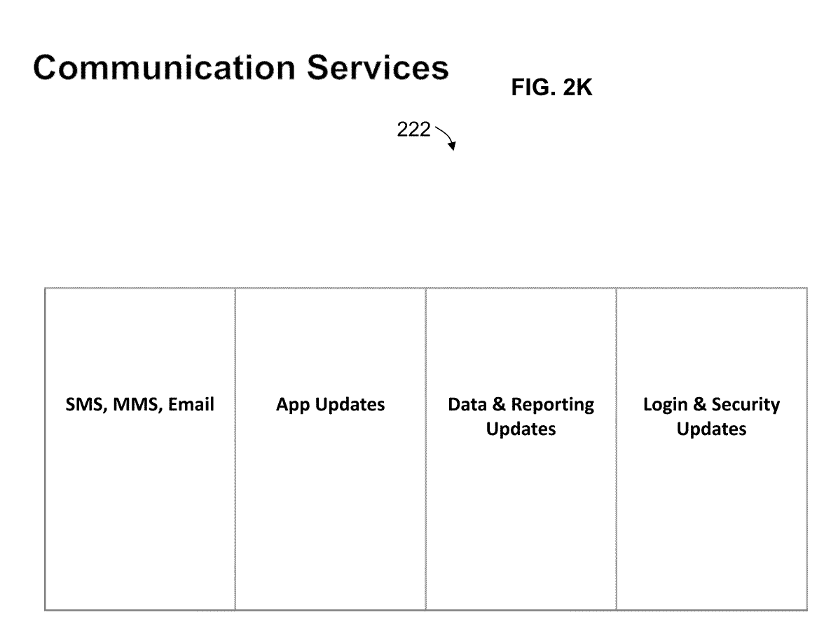

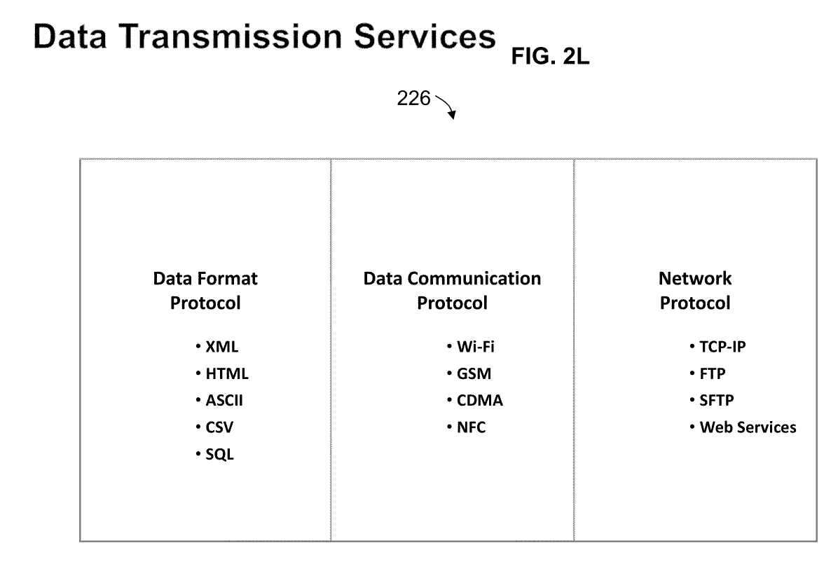

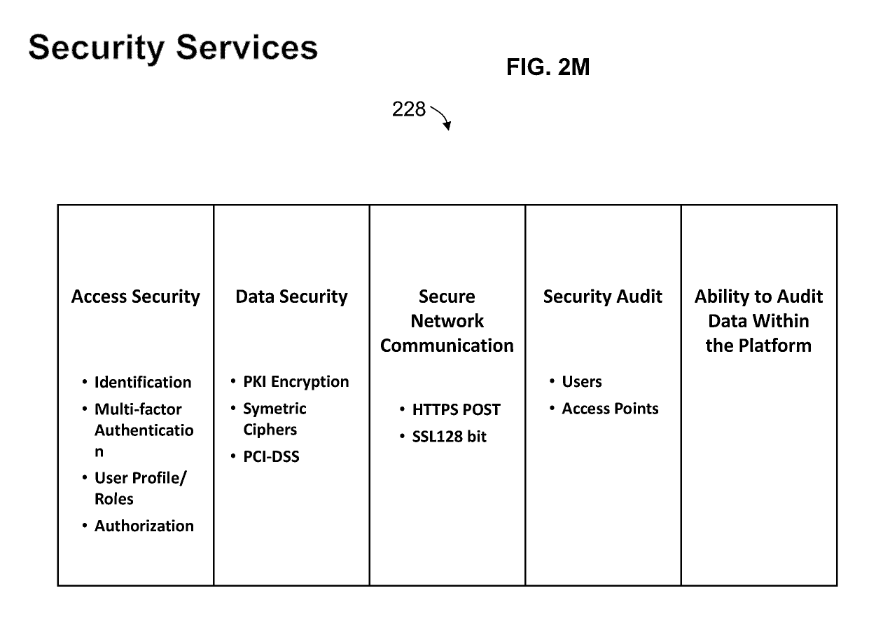

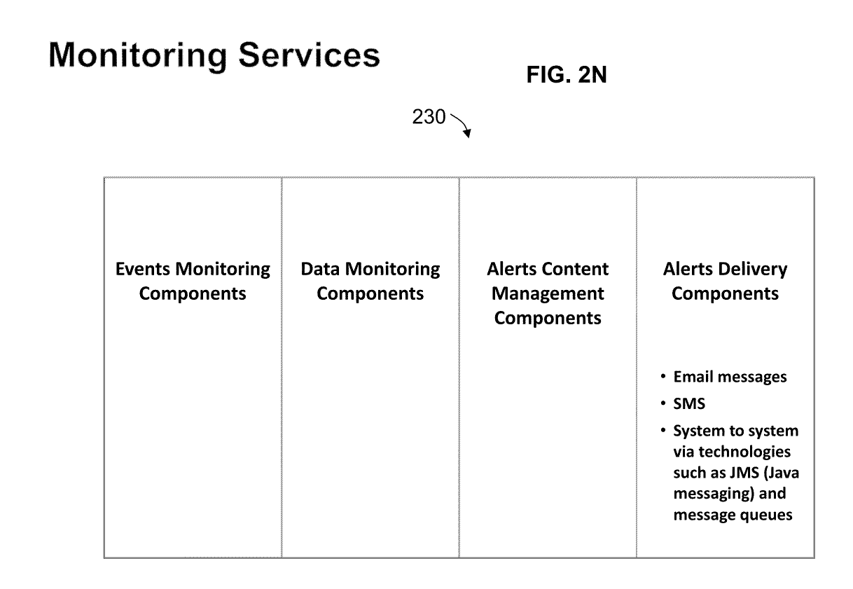

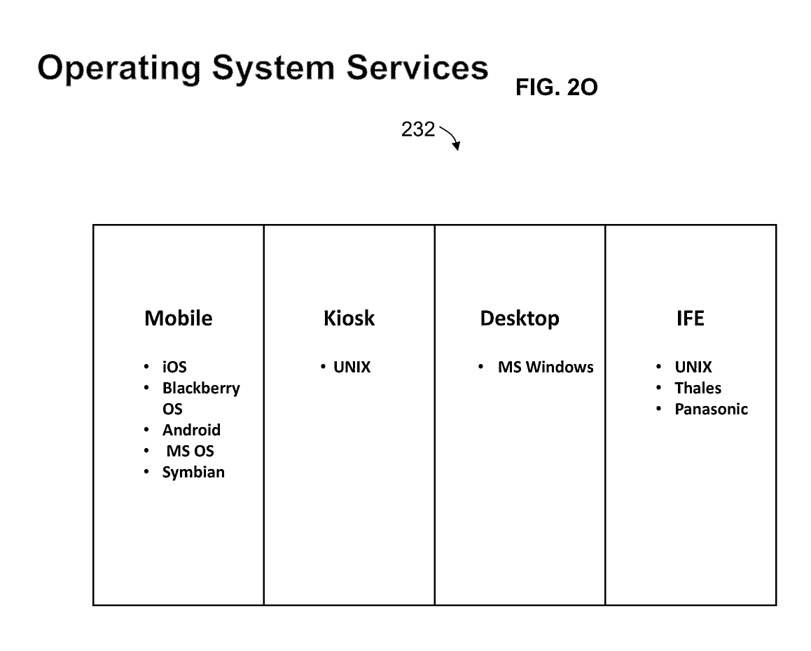

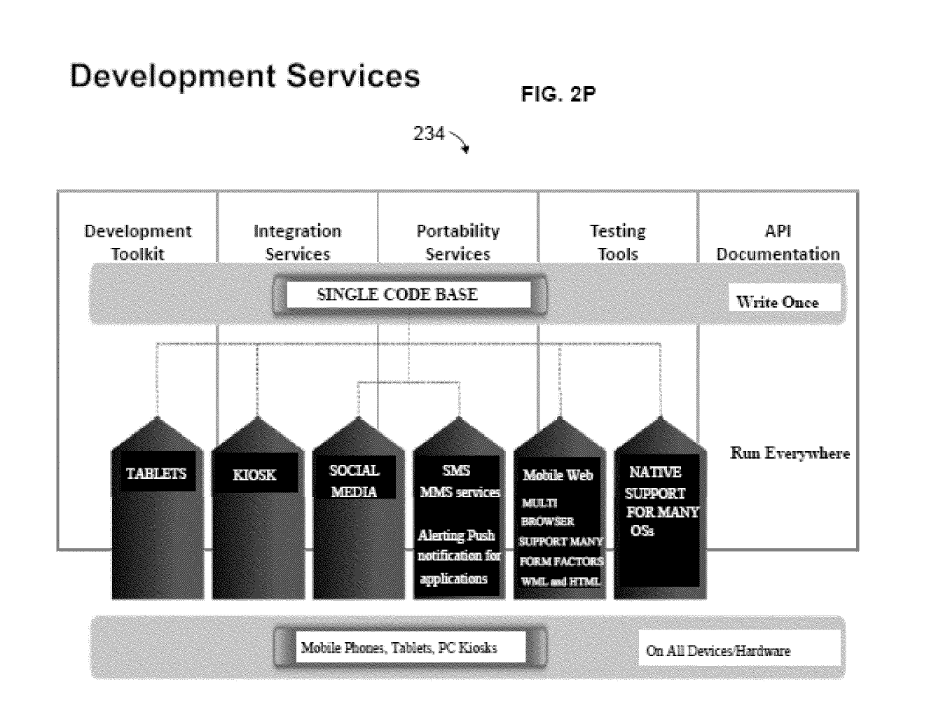

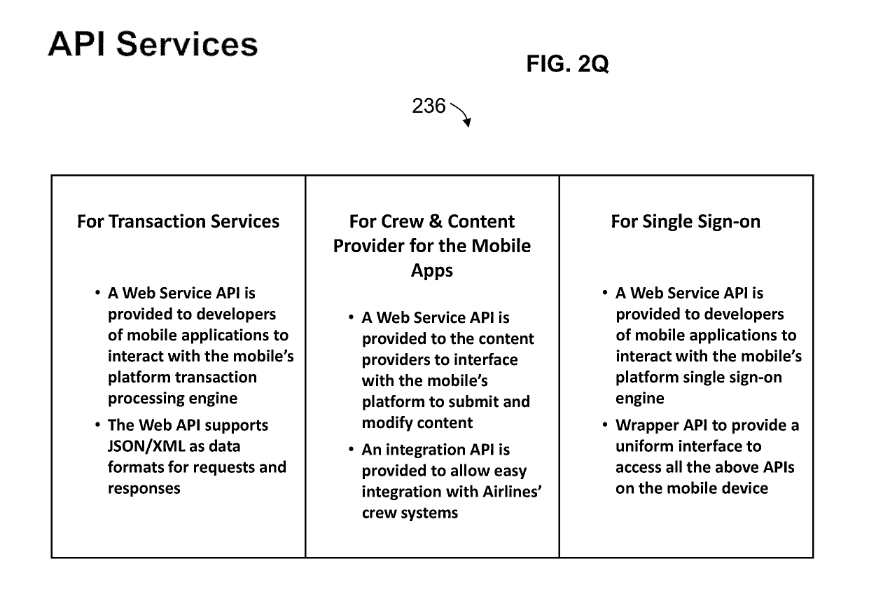

FIG. 2A illustrates a system functional architecture according to one embodiment that supports integration of devices 150 into the mobile retail environment. System 200 includes access layer 202 and presentation layer 204. Access layer 202, illustrated in FIG. 2B, includes devices such as POS devices 108, mobile devices 150, in-flight entertainment systems (i.e. seat-back) devices 152, kiosk devices 154, and any general device with a Web browser 156.

Presentation layer services 204 interface with access layer devices to provide consumer services 206, crew services 208, airline services 210, content provider services 212, reporting services 214, analytics 216, transaction services 218, generic user services 220, communication services 222, database services 224, data transmission services 226, security services 228, monitoring services 230, operating systems services 232, development services 234, and API services 236. Each of these services can be accessed through one or more of the access services 202. Examples of each of these services are illustrated, respectively, in FIGS. 2C-2Q.

In another aspect of the invention, off-line sales on-board a mobile retail environment are supported using mobile devices 150. Embodiments of this aspect of the invention utilize a mobile host module that communicates with BOS system servers 100 when connectivity is available between the mobile host module and servers 100. The mobile host module uses information received from servers 100 to establish one or more specific mobile stores for one or more travelers.

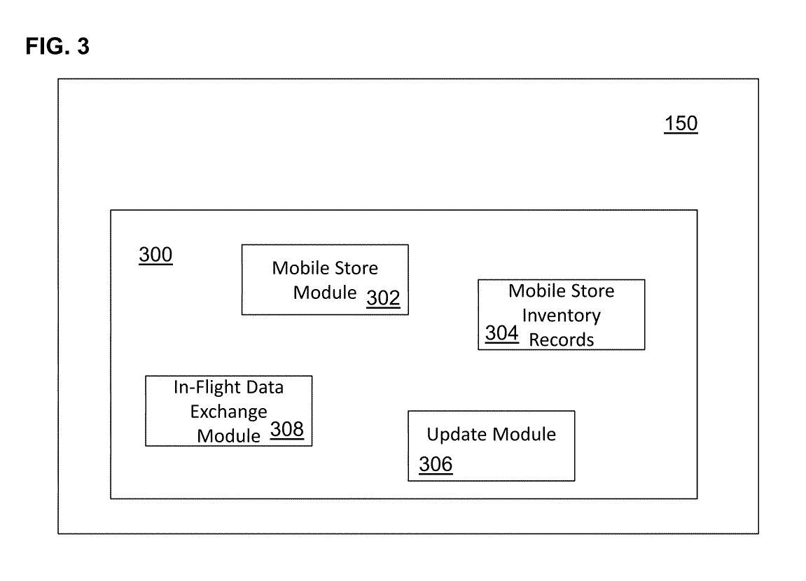

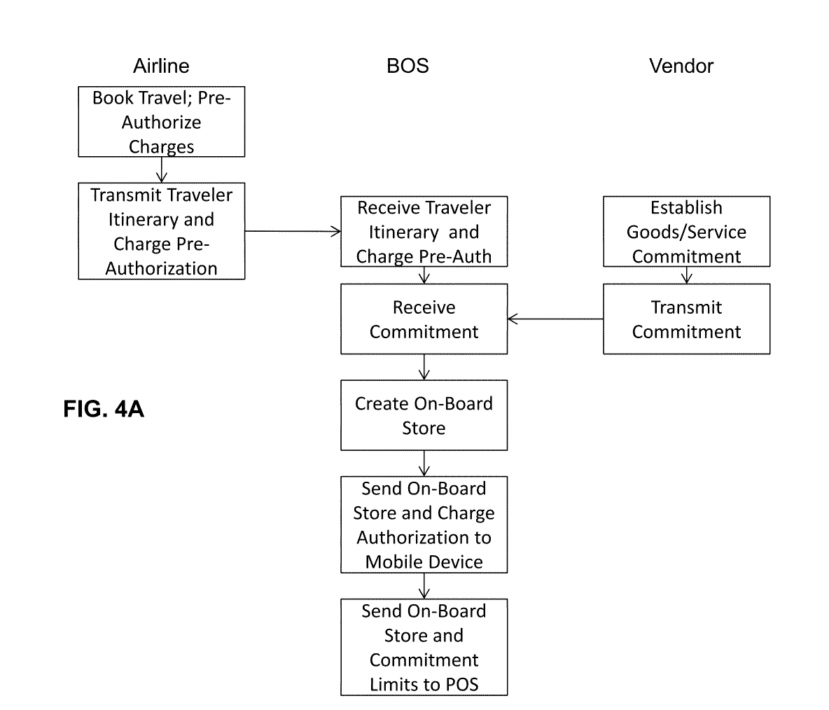

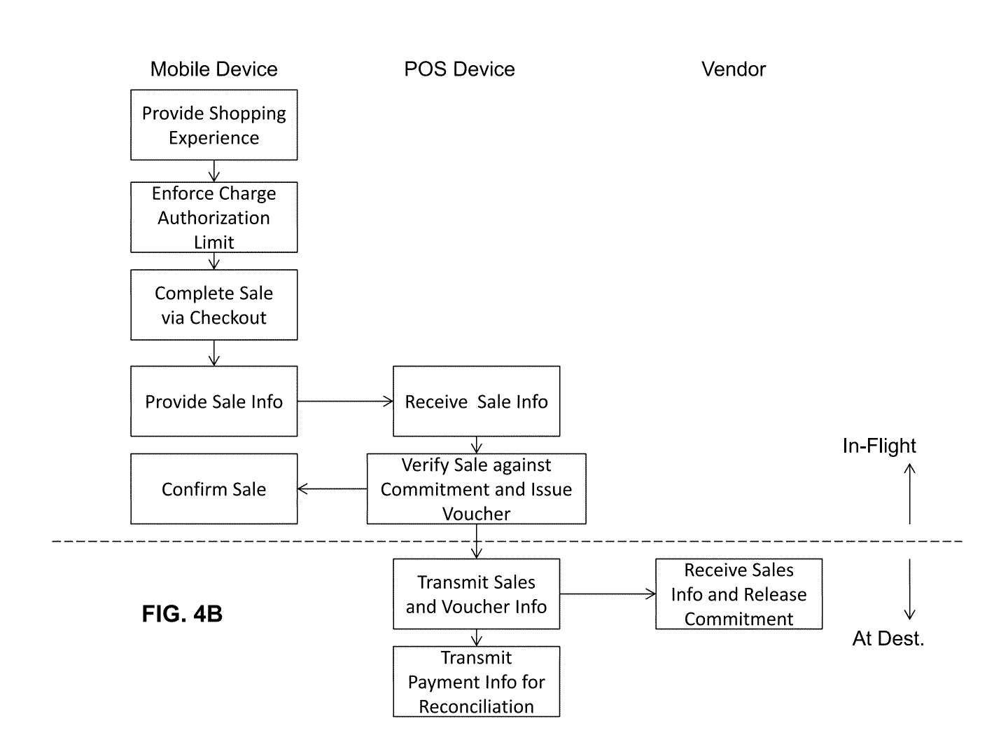

According to one type of embodiment, a mobile host module is implemented in the mobile device 150 of each traveler. This mobile host module, described in greater detail in FIGS. 3 and 4A-4B, supports one mobile store for the traveler, and enables the traveler to shop in the mobile store even when there is no connectivity with servers 100, which may be the case during transit in a vehicle.

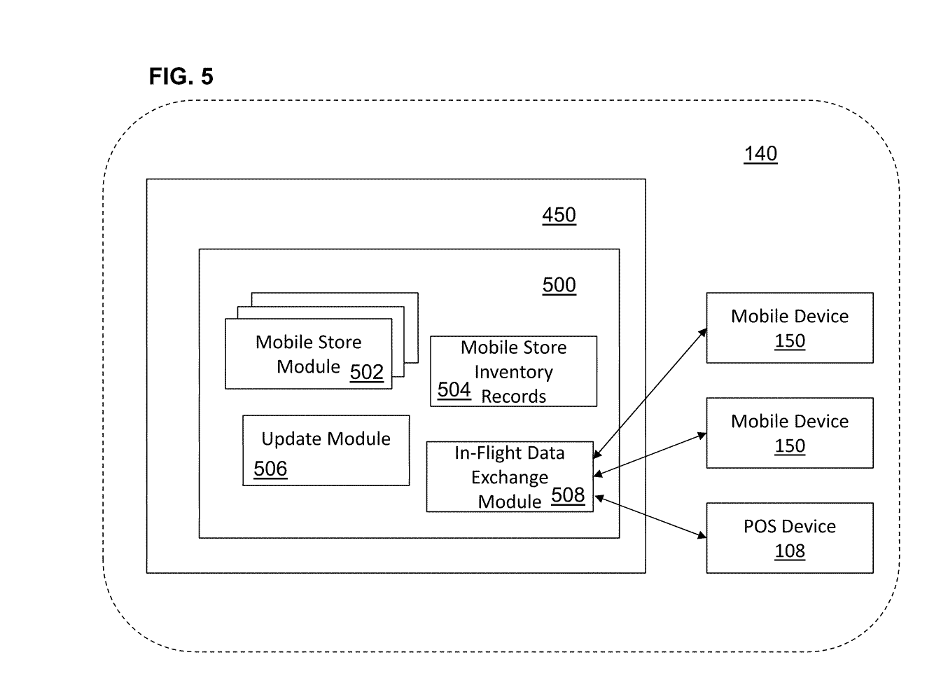

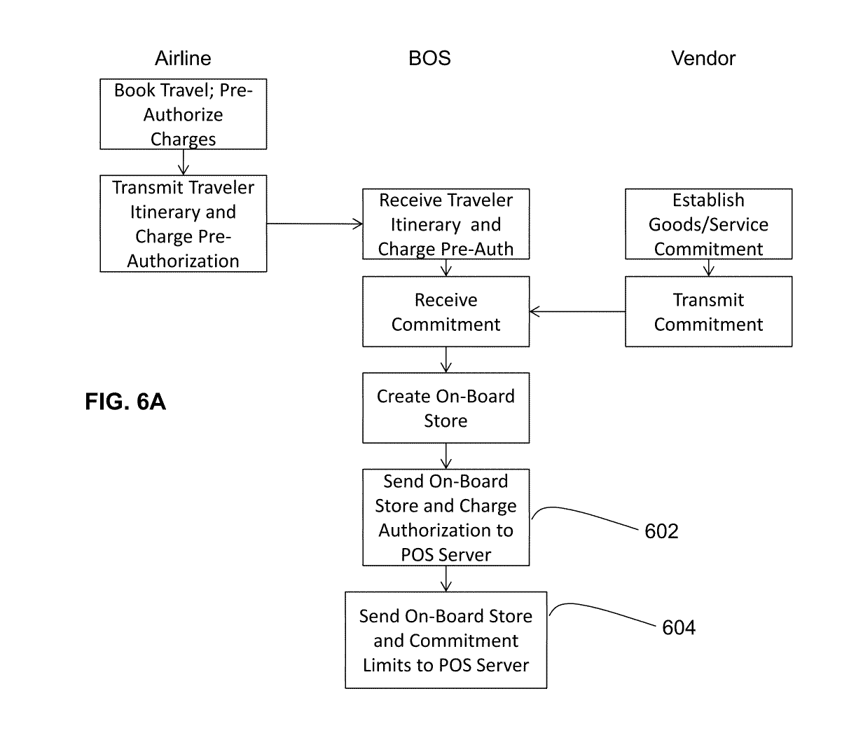

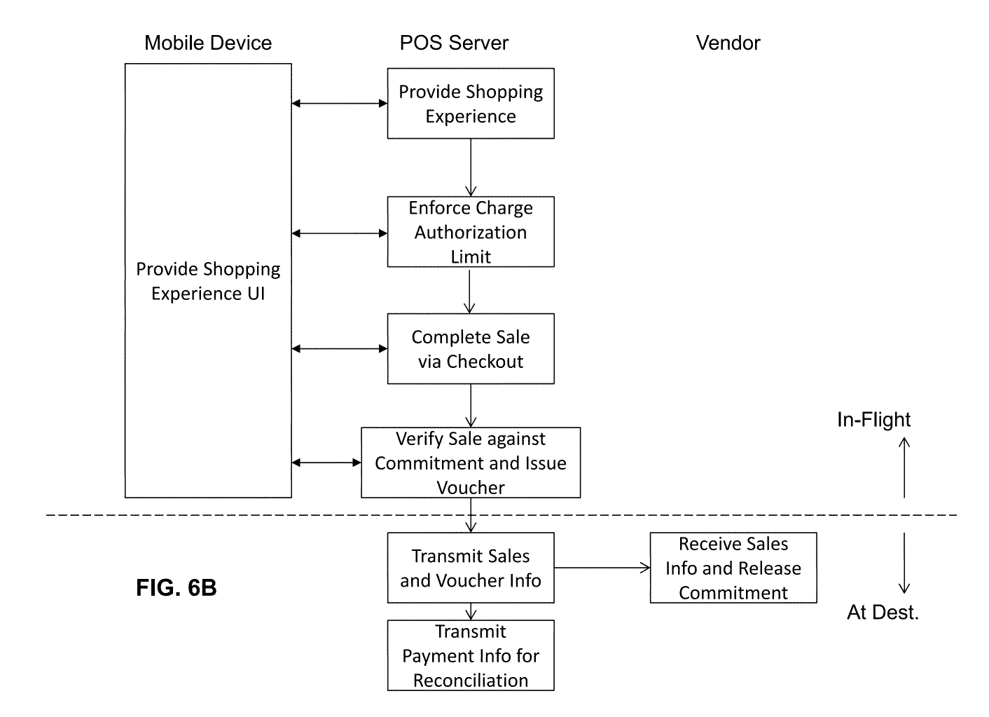

According to another type of embodiment, the mobile host module is implemented in a point-of-sale server that is present in the mobile retail environment and has connectivity with mobile devices of travelers in that environment. The point-of-sale server may be installed in the vehicle, or may be carried in and out of the vehicle. Also, the point-of-sale server may be incorporated into a point-of-sale device such as POS device 108, which can have a local user interface, credit card reader, etc. In a related embodiment, the point-of-sale server is a separate computing device without a local user interface. The mobile host module according to this type of embodiment can support one, or multiple, mobile stores. In the case of multiple mobile stores being supported, each traveler in the mobile retail environment may have a specific store defined for the traveler, which has goods and services available based on that traveler's specific itinerary and, where applicable, any preconfigured limitations such as charge authorization. In this type of embodiment, the mobile host module provides the mobile store to each traveler's mobile device. This can be accomplished via standard web browser interface over an intranet established using vehicle network 140. FIGS. 5 and 6A-6B and the corresponding description below provide more details on this type of embodiment.

Referring to FIG. 3, in one embodiment, mobile device 150 is configured with specific modules to support off-line in-flight purchases. The term “module” as used herein means a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor(s) of one or more general purpose computers (such as the one described in greater detail below) that execute an operating system, system programs, and application programs, while also implementing the module using multitasking, multithreading, distributed (e.g., cloud) processing, or other such techniques. Accordingly, each module can be realized in a variety of suitable configurations, and should not be limited to any particular implementation exemplified herein.

In one particular embodiment, mobile device 150 executes a mobile host module 300 that includes mobile store module 302, mobile store inventory records module 304, update module 306, and in-flight data exchange module 308. In a related embodiment, these four modules of the mobile host module 300 are implemented using an application, or “app,” that is downloaded to mobile device 150 and installed to execute on the device. Once the app is installed, the program instructions of the app configure the computing hardware of mobile device 150 to implement modules 302, 304, 306, and 308.

Mobile store module 302 provides an interactive user experience that allows the traveler to browse goods or services that are available in the mobile retail environment. The mobile retail environment is defined in one sense based on what is actually available. To this end, mobile store inventory records module 304 represents the goods and services that are available in each particular mobile retail environment. Update module 306 facilitates data connectivity, with servers 100 to update the stored data in module 304. In one embodiment, for flight, or each leg of a particular itinerary, update module 306 receives appropriate inventory information. In-flight data exchange module 308 facilitates interaction with a POS device 108 or other device on vehicle network 140. This interaction can include wireless communications of mobile store inventory information, transactions, authorizations, and the like.

FIG. 4A is a flow diagram illustrating a process for preparing mobile device 150 for an off-line mobile retail environment according to one example embodiment. Each of the three columns labeled Airline, BOS (back office system) and Vendor represents a sequence of events performed by each respective system. First, a passenger books travel with the airline. This can be done online or via telephone with a customer service representative. Optionally, as part of the booking process, the customer, who is the traveler-to-be at this stage, or person or organization affiliated with the traveler-to-be, authorizes a certain amount of charges on a credit card, corporate account, or other suitable financial instrument. This amount can be processed at this early stage and held to ensure payment in reconciliation. The customer's travel itinerary including the traveler's identity and flight information, as well as the charge authorization information, are transmitted to the back-office system on servers 100.

In a related embodiment, the vendor establishes a goods or services commitment with the BOS. This process involves the vendor essentially guaranteeing that the goods or services in certain committed amounts will be available to travelers in the mobile retail environment. For instance, if the vendor is a tour operator at a destination, then a commitment represents a reservation of a certain number of customer spots available in each of the tours being offered. The commitment is transmitted to the BOS.

The BOS receives the traveler and charge authorization from the airline, and receives the commitment information from the vendor. Using this information, the BOS creates the on-board store. The on-board store in this case describes the goods and services that are available to travelers on each particular flight.

The traveler has mobile device 150 and the device is configured with update module 306. Update module 306 causes mobile device 150 to connect periodically, or on a push basis in response to events such as itinerary creation or changes, with servers 100 and receive mobile store inventory records to be kept by module 304. These records are specific to the traveler's itinerary and preferably represent only those items which are available to the traveler on his or her flight(s).

The servers 100 also send the on-board store information, along with commitment limits provided by the vendor to the POS devices 108 or other devices on mobile network 140, that will be available on the flight(s).

Referring now to FIG. 4B, the three columns represent actions taken by mobile device 150, POS device 108, and the Vendor. In the flight, mobile store module 302 on the mobile device provides a shopping experience to the traveler. In the shopping experience, the charge authorization limits established at the time of booking of the flight are enforced. Once the traveler selects the good or services he or she wishes to buy, the sale is completed via checkout using a shopping cart process or other suitable user-friendly process.

At this stage, the sale information is provided to POS device 108, which proceeds to check if the selected goods or services are still available (since other shoppers may have preempted this traveler insofar as the commitment amounts are concerned). This information may be transmitted to the POS device over vehicle network 140. Alternatively, this information may be generated in the form of a bar code, which is displayed on the screen of mobile device 150 and read by a bar code reader on POS device 108. Once the sale is verified against the commitments by the Vendor, a voucher is issued to the traveler (e.g., in the form of a printed-out slip, or in the form of a numerical code associated with the completed transaction) and the sale is confirmed for the traveler.

At the destination, POS device 108 transmits the sales and voucher codes to the Vendor, who is now prepared to deliver the goods or services to the traveler upon his or her arrival. Also, the payment information is provided to servers 100, which will be used for reconciliation with the credit card issuer.

Referring now to FIG. 5, mobile host module 500 is illustrated as being implemented on point-of-sale server 450, which is configured to communicate over vehicle network 140 with other devices such as mobile devices 150 and separate POS device 108. In a related embodiment, point-of-sale server 450 is integrated with one or more POS devices 108 (which, in the case of multiple POS devices 108, can implement point-of-sale server 450 using distributed processing techniques).

Mobile host module 500 includes mobile store module 502, which is similar to mobile store module 302, except that this module can manage multiple stores, each corresponding to a different traveler to be in the mobile retail environment. Mobile store inventory records module 504 and update module 506 are analogous to modules 304 and 306 described above. In-flight data exchange module 508 facilitates communication with other devices in vehicle network 140, including with module devices 150 and, optionally, with POS device(s) 108.

In a related embodiment, in-flight data exchange module 508 and mobile store module 502 operate together to provide an intranet site that is accessible to mobile devices 150 using a standard Web browser. This avoids having to install special software apps on mobile devices 150, and ensures compatibility across many diverse platforms.

In another embodiment, these modules include an option for hosting a cloud computing model that interacts with a specialized application installed on certain ones of mobile device 150. This approach can be beneficial for use with mobile phones and other mobile devices 150 with limited data communications capability and smaller displays, and can provide a highly-usable user experience with a relatively smaller amount of data having to be communicated to, and displayed on, those mobile devices 150 compared with the above approach of using a standard web browser. In one such implementation, mobile devices 150 optionally have installed a local app that provides display and user interface forms, or templates, into which the mobile store information can be transmitted to be displayed. Instead of having to transmit the screen layouts, controls, etc., only the contents of the mobile store (and related content information) may be exchanged.

FIG. 6A is a modified process according to one embodiment similar to the process of FIG. 4A, except that the process of FIG. 6A is specifically adapted to configurations in which the mobile host module is implemented in a point-of-sale server 450. The operations depicted in FIG. 6A are essentially analogous to those of the process of FIG. 4A, except blocks 602 and 604. In block 602, the on-board store and charge authorization information is sent to the point-of-sale server instead of to the mobile device. Parts of the process are of course repeated for each individual traveler so that the point-of-sale server is configured with multiple mobile stores customized to individual travelers' itineraries. In block 604, the on-board store and commitment limits are sent to the point-of-sale server 450. This operation can be regarded as a generalization of the corresponding operation of FIG. 4A, since the point-of-sale server 450 essentially performs similar transaction functionality as the POS device 108 of the embodiments described above.

FIG. 6B illustrates in-flight and post-flight operations performed by mobile device 105, point-of-sale server 450, and the vendor of goods/services. Similarly to the process depicted in FIG. 4B, the actions are presented in three columns. In the flight, mobile store module 502 on the point-of-sale server 450 provides a shopping experience to the traveler. However, the user interface of the shopping experience is provided via the traveler's mobile device, which is interfaced with the point-of-sale server 450 via vehicle network 140, e.g., an intranet connection as described above. In the shopping experience, the charge authorization limits established at the time of booking of the flight are enforced. Once the traveler selects the good or services he or she wishes to buy, the sale is completed via checkout using a shopping cart process or other suitable user-friendly process.

Point-of-sale server 450 then checks if the selected goods or services are still available (since other shoppers may have preempted this traveler insofar as the commitment amounts are concerned). If the transaction cannot be verified due to a lack of availability of the desired goods or services, an interactive process is employed to inform the traveler, and offer alternative selections. Once the sale is verified against the commitments by the Vendor, a voucher is issued to the traveler (e.g., in the form of a printed-out slip, or in the form of a numerical code associated with the completed transaction). These steps may be performed using a POS device 108.

At the destination, point-of-sale server 450 transmits the sales and voucher codes to the Vendor, who is now prepared to deliver the goods or services to the traveler upon his or her arrival. Also, the payment information is provided to servers 100, which will be used for reconciliation with the credit card issuer.

The exemplary approaches described in the embodiments above avoids having to take payment on-board, and ensures that the traveler is offered only goods and services that are available, thereby virtually eliminating the need for charge-backs due to the carrier's fault.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method for configuring a personal mobile retail environment for mobile shopping utilizing a mobile device of a traveler, the personal mobile retail environment being associated with specific scheduled itinerary including a departure time, a departure location, a destination arrival time and a destination arrival location, and a transit period that exists when the mobile retail environment is traveling between the departure location and destination arrival location, the method comprising:
receiving itinerary information relating to the traveler;
receiving commitment information representing vendor/supplier-committed availability of the goods or services for purchase during the transit period and available for delivery during the transit period or at the destination arrival location;
generating an on-board store definition based on the itinerary information and commitment information, wherein the on-board store definition includes a description of the goods or services that are available in the personal mobile retail environment; and
sending the on-board store definition to a mobile host module accessible via the mobile device of the traveler.

2. The method of claim 1, wherein the mobile host module is executed locally on the mobile device of the traveler.

3. The method of claim 1, wherein the mobile host module is executed on a mobile point-of-sale server located in the mobile retail environment at least during the transit period and that is distinct from, but communicatively connectable with, the mobile device of the traveler.

4. The method of claim 1, further comprising:
receiving charge pre-authorization information representing a monetary limit for the personal mobile retail environment.

5. The system of claim 4, wherein in receiving the charge pre-authorization information, the charge pre-authorization information is provided by a transportation provider information system.

6. The method of claim 4, further comprising:
sending the on-board store definition and the charge pre-authorization information to a point-of-sale device to be located in the mobile retail environment during the transit period.

7. The method of claim 4, further comprising:
sending the on-board store definition and the commitment information to a point-of-sale device to be located in the mobile retail environment during the transit period.

8. A system for configuring a personal mobile retail environment for mobile shopping utilizing a mobile device of a traveler, the personal mobile retail environment being associated with specific scheduled itinerary including a departure time, a departure location, a destination arrival time and a destination arrival location, and a transit period that exists when the mobile retail environment is traveling between the departure location and destination arrival location, the system comprising:
a back-office system of at least one computer server configured to be communicatively coupled with a transportation provider information system, a vendor/supplier information system, a point-of-sale device on-board a vehicle, and the mobile device of the traveler, wherein the back-office system includes a non-transitory storage medium containing instructions executable on the at least one computer server that, when executed, cause the back-office system to:
receive itinerary information relating to the traveler provided by the transportation provider information system;
receive commitment information representing vendor/supplier-committed availability of the goods or services for purchase during the transit period and available for delivery during the transit period or at the destination arrival location, the commitment information being provided by the vendor/supplier information system;
generate an on-board store definition based on the itinerary information and commitment information, wherein the on-board store includes a description of the goods or services that are available in the personal mobile retail environment; and
send the on-board store definition to a mobile host module that is accessible via the mobile device of the traveler.

9. The method of claim 8, wherein the mobile host module is executed locally on the mobile device of the traveler.

10. The method of claim 8, wherein the mobile host module is executed on a mobile point-of-sale server located in the mobile retail environment at least during the transit period and that is distinct from, but communicatively connectable with, the mobile device of the traveler.

11. The system of claim 8, wherein the back-office system is further configured to receive charge pre-authorization information representing a monetary limit for the personal mobile retail environment.

12. The system of claim 11, wherein the back-office system is further configured to receive charge pre-authorization information as provided by the transportation provider information system.

13. The system of claim 11, wherein the back-office system is further configured to send the on-board store definition and the charge pre-authorization information to a point-of-sale device to be located in the mobile retail environment during the transit period.

14. The system of claim 11, wherein the back-office system is further configured to send the on-board store definition and the commitment information to a point-of-sale device to be located in the mobile retail environment during the transit period.

15. A mobile device configured to implement a personal mobile retail environment for off-line shopping for a traveler, the personal mobile retail environment being associated with specific scheduled itinerary including a departure time, a departure location, a destination arrival time and a destination arrival location, and a transit period that exists when the mobile retail environment is traveling between the departure location and destination arrival location, the mobile device comprising:
a mobile store inventory records module representing goods or services available for purchase during the transit period and available for delivery during the transit period or at the destination arrival location, wherein the mobile store definition was generated based on a travel itinerary of the traveler; and
a mobile store module configured to facilitate an interactive shopping experience for the traveler based on the goods or services represented in the mobile store inventory records module, the mobile store module including logic for facilitating selection, by the traveler, of the goods or services for purchase, and for enforcing a predetermined monetary limit on purchases available via the personal mobile retail environment.

16. The mobile device of claim 15, further comprising:
a data exchange module configured to provide sale information representing the selection of goods or services to a point-of-sale device, wherein the point-of-sale device is configured to verify the selection against a committed availability of the goods or services.

17. The mobile device of claim 16, wherein the data exchange module is configured to display a bar code readable by the point-of-sale device.

18. The mobile device of claim 16, wherein the data exchange module is configured to wirelessly communicate with the point-of-sale device over a vehicle network.

19. A method for implementing a personal mobile retail environment for mobile shopping utilizing a mobile device of a traveler, the personal mobile retail environment being associated with specific scheduled itinerary including a departure time, a departure location, a destination arrival time and a destination arrival location, and a transit period that exists when the mobile retail environment is traveling between the departure location and destination arrival location, the method comprising:
receiving, by the mobile device, prior to the departure time, a mobile store definition that describes goods or services available for purchase during the transit period and available for delivery during the transit period or at the destination arrival location, wherein the mobile store definition was generated based on a travel itinerary of the traveler;
receiving, by the mobile device, a charge limit indication representing a monetary limit for purchases available via the personal mobile retail environment; and
providing, by the mobile device, an interactive shopping experience for the traveler based on the mobile store definition, including facilitating selection by the traveler of goods or services for purchase, and enforcing the monetary limit based on the charge limit indication.

20. The method of claim 19, further comprising:
by the mobile device, providing sale information representing the selection of goods or services to a point-of-sale device, wherein the point-of-sale device is configured to verify the selection against a committed availability of the goods or services.

21. The method of claim 20, wherein providing the sale information to the point-of-sale device includes displaying a barcode.

22. The method of claim 20, wherein providing the sale information to the point-of-sale device includes transmitting the sale information via a vehicle network.
